(19) United States
(12) Patent Application Publication
(10) Pub. No.: US 2026/0299535 A1
(43) Pub. Date: Oct. 1, 2026

(54) TRANSITIONING A PRODUCTION FACILITY TO A TARGET OPERATING STATE BASED ON CARBON DIOXIDE EMISSIONS

(71) Applicant: Schlumberger Technology Corporation, Sugar Land, TX (US)

(72) Inventor: Clare Schoene, Houston, TX (US)

(21) Appl. No.: 19/095,221

(22) Filed: Mar. 31, 2025

(51) Int. Cl. G05B 13/04

(52) U.S. Cl. CPC G05B 13/048; G05B 13/042

(57) ABSTRACT

A production facility control system may apply a first predictive controller to the current operating state to generate a first transitionary state between the current operating state and a target operating state. The first transitionary state utilizes a first combination of equipment operating in the current operating state and results in first carbon dioxide emissions. A production facility control system may apply a second predictive controller to the current operating state to generate a second transitionary state between the current operating state and the target operating state. The second transitionary state utilizes a second combination of equipment different than the first combination of equipment and resulting in second carbon dioxide emissions. A production facility control system may select one of the first transitionary state or the second transitionary based on the first carbon dioxide emissions and the second carbon dioxide emissions.

### BACKGROUND OF THE DISCLOSURE

Production facilities produce some of their highest carbon dioxide emissions during start up and shut down. These transient operations cause power consuming equipment such as compressors and pumps to operate at very inefficient operating points for extended periods of time. Such inefficient operating points may result in higher carbon dioxide emissions when transitioning between operating states until a new efficient operating point is reached.

### SUMMARY

In some aspects, the techniques described herein relate to a method implemented at an oil and gas production facility. A predictive control manager receives a current operating state for the oil and gas production facility. The predictive control manager receives a target operating state for the oil and gas production facility. The predictive control manager applies a first predictive controller to the current operating state to transition the oil and gas production facility from the current operating state to the target operating state. The first predictive controller generates a first transitionary state between the current operating state and the target operating state based on first carbon dioxide emissions. The first transitionary state utilizes a first combination of equipment operating in the current operating state. The predictive control manager applies a second predictive controller to the current operating state to transition the oil and gas production facility from the current operating state to the target operating state. The second predictive controller generates a second transitionary state between the current operating state and the target operating state based on second carbon dioxide emissions. The second transitionary state utilizes a second combination of equipment different than the first combination of equipment. The predictive control manager selects one of the first transitionary state or the second transitionary based on the first carbon dioxide emissions and the second carbon dioxide emissions.

In some aspects, the techniques described herein relate to a method implemented at an oil and gas production facility. A production facility control system measures a facility input to the oil and gas production facility. Based on the facility input, the production facility control system generates a target operating state for the oil and gas production facility to accommodate the facility input. The production facility control system measures operating parameters of a plurality of units of equipment. At least a portion of the plurality of units of equipment are turned on. Based on the operating parameters, the production facility control system generates a current operating state for the oil and gas production facility. Based on the operating parameters and the facility input, the production facility control system generates a first transitionary state between the current operating state and the target operating state. The first transitionary state has first carbon dioxide emissions based on changing the operating parameters. Based on the operating parameters and the facility input, the production facility control system generates a second transitionary state between the current operating state and the target operating state. The second transitionary state has second carbon dioxide emissions based on changing the portion of the plurality of units of equipment that are turned on. Based on the first carbon dioxide emissions being lower than the second carbon emissions, the production facility control system changes the oil and gas production facility to the first transitionary state, and based on the second carbon emissions being lower than the first carbon emissions, the production facility control system changes the oil and gas production facility to the second transitionary state.

In some aspects, the techniques described herein relate to an oil and gas production facility. The production facility includes a plurality of units of equipment configured to process a facility input of an oil and gas stream and a plurality of sensors connected to the plurality of units of equipment to measure an operating status of the plurality of units of equipment. The production facility includes a processor and memory, the memory including instructions that cause the processor to receive a current operating state for the oil and gas production facility based on the operating status of the plurality of units of equipment. The processor receives a target operating state for the oil and gas production facility based on a change to the facility input. The processor applies a first predictive controller to the current operating state to transition the oil and gas production facility from the current operating state to the target operating state. The first predictive controller generates a first transitionary state between the current operating state and the target operating state based on first carbon dioxide emissions of the plurality of units of equipment. The first transitionary state utilizes a first combination of the plurality of units of equipment operating in the current operating state. The processor applies a second predictive controller to the current operating state to transition the oil and gas production facility from the current operating state to the target operating state. The second predictive controller generates a second transitionary state between the current operating state and the target operating state based on second carbon dioxide emissions of the plurality of units of equipment. The second transitionary state utilizes a second combination of the plurality of units of equipment different than the first combination of equipment. The processor selects one of the first transitionary state or the second transitionary based on the first carbon dioxide emissions and the second carbon dioxide emissions.

In some aspects, the techniques described herein relate to the oil and gas production facility, wherein the instructions further cause the processor to implement the selected one of the first transitionary state or the second transitionary state.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a production facility control system, according to at least one embodiment of the present disclosure.

FIG. 2 is a schematic representation of a production facility control system, according to at least one embodiment of the present disclosure.

FIG. 3 is a representation of a flow diagram of a production facility control system, according to at least one embodiment of the present disclosure.

FIG. 4 is a representation of a flow diagram of a production facility control system, according to at least one embodiment of the present disclosure.

FIG. 5 is a representation of a flow diagram of a production facility control system, according to at least one embodiment of the present disclosure.

FIG. 6 is a flowchart of a method for controlling a production facility, according to at least one embodiment of the present disclosure.

FIG. 7 is a flowchart of a method for controlling a production facility, according to at least one embodiment of the present disclosure.

FIG. 8 is a representation of a computing system, according to at least one embodiment of the present disclosure.

### DETAILED DESCRIPTION

This disclosure generally relates to devices, systems, and methods for controlling changes in operating state of an oil and gas production facility (also referred to herein more generally as a “production facility”) to reduce carbon dioxide emissions. Changing the operating state of the equipment of an oil and gas facility may cause the equipment to run, for during the transition between operating states, less efficiently. Inefficient equipment operation may result in increased carbon dioxide emissions. For example, equipment typically has an efficient operating range, in which carbon emissions are reduced. Changing the operating state may cause the equipment to operate at lower or higher than the efficient operating range, thereby increasing carbon dioxide emissions for the output of the equipment.

Conventionally, startup of an oil and gas production facility is an extended process that places the oil and gas equipment in the transient operating state for extended periods of time. For example, equipment may not be started or stopped until the existing equipment exceeds predefined thresholds, based on the training and experience of an operator, or based on other pre-defined metrics. The ramp-up or ramp-down of the equipment may occur over a period of time, causing extended and repeated periods in the transient operating state. This may result in increased carbon dioxide emissions during changes to the operating state of the oil and gas production facility.

In accordance with at least one embodiment of the present disclosure, a production facility control system may include a predictive control manager. The predictive control manager may receive a current operating state and a target operating state of the production facility. The predictive control manager may identify one or more pathways to transition the production facility from the current operating state to the target operating state. In some situations, the predictive control manager may include a plurality of predictive controllers that may generate a pathway to the target state based on a set of inputs or constraints. For example, a first predictive controller may generate a first pathway to the target based on the equipment currently operating. A second predictive controller may generate a second pathway to the target based on startup or shutdown of any equipment at the production facility. The predictive control manager may receive both pathways and identify which of the pathways may result in less total emissions. The predictive control manager may then implement the selected pathway, or at least the first step or steps along the selected pathway. This may place the production facility in a transitionary state.

This process may be iterative. For example, the predictive control manager may then receive the new current operating state of the production facility in the transitionary state. The predictive control manager may generate new first pathways and new second pathways based on the new current operating state, and select one of the new pathways based on the carbon emissions of the new pathways. In this manner, the predictive control manager may transition the production facility to the target operating state based on changing conditions and how those changing conditions impact the carbon emissions. This may reduce the carbon emissions of the production facility while transitioning to a target operating state.

As illustrated by the foregoing discussion, the present disclosure utilizes a variety of terms to describe features and advantages of the production facility control system. Additional detail is now provided regarding the meaning of such terms. For example, as used herein, the term “operating state” refers to the condition of a production facility. For example, the operating state of the production facility may include a representation of a status of various units of equipment. The status of the units of equipment may include operating, not operating, operating inputs, operating outputs, motor speed, motor energy consumption, pressure, temperature, volumetric flow rate, mass flow rate, fuel consumption, any other status, and combinations thereof, including inclusions or exclusions of any of the foregoing. In some embodiments, the operating state includes the status of a single unit of equipment. In some embodiments, the operating state includes the individual status of multiple units of equipment. In some embodiments, the operating state includes a combination of statuses of units of equipment, including summations or other functions of multiple units of equipment. In some embodiments, the operating state may include the overall plant status, including overall production plant inputs, overall plant outputs, plant input composition, plant output composition, volume of gas sent to flare, total energy consumption, any other overall plant status, and combinations thereof, including inclusions and exclusions of any of the foregoing. The operating state may be determined in any manner. For example, the operating state may be determined using sensed conditions using various sensors located at various positions around the production plant. In some examples, the operating state may be estimated at a point in the future, based on measured or predicted changes in the operating state.

As used herein, a predictive controller is a model that simulates the operating state of a production facility at a time in advance of a current operating state. The predictive controller may estimate how changes in the operating status of one or more units of equipment may impact the operating state of the production facility. In some embodiments, the predictive controller may identify how changes in the operating state of the production facility may impact one or more analysis metrics. For example, the analysis metrics may include one or more of carbon dioxide emissions, electricity consumption, fuel consumption, and so forth. The predictive controller may simulate the operating state based on one or more additional models. For example, the predictive controller may utilize a facility model that receives inputs (such as sensor measurements) to model an operating state of the production facility, including system dynamics and carbon emissions. The predictive controller may simulate the operating state of the production facility based on the inputs and simulated changes to the inputs.

In some embodiments, a predictive controller may prepare recommendations to change the operating status of one or more units of equipment and/or implement the changes to the equipment operating status. For example, the predictive controller may minimize a cost function for the production facility. In some examples, the predictive controller may minimize a cost function over a receding horizon. The predictive controller may generate recommendations based on the solution to the cost function, and update the solution based on identified changes to the system. As a specific, non-limiting example, the predictive controller may utilize receding horizon control techniques, model predictive control techniques, dynamic matric control (DMC), Kalman filtering and its derivatives (e.g., extended Kalman filter), or other predictive control techniques that enable the generation of recommendations and/or the implementation of changes to the operating state of the production system based on the impact of predicted future operating states.

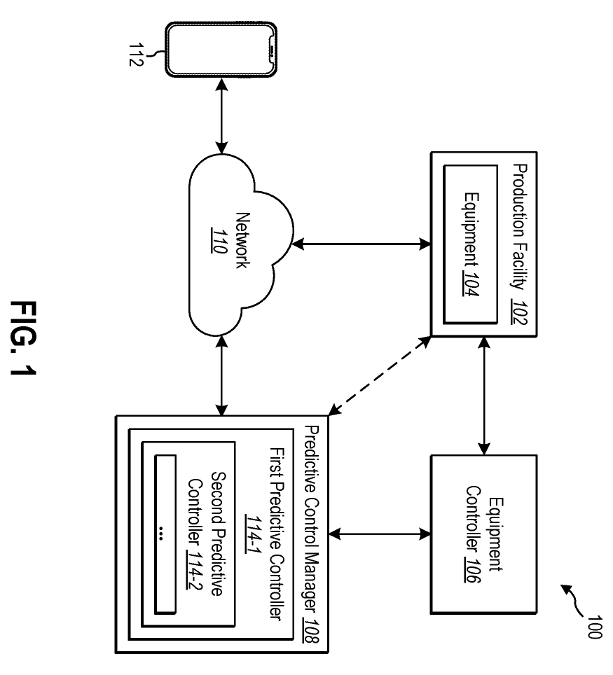

FIG. 1 is a schematic representation of a production facility control system 100, according to at least one embodiment of the present disclosure. The production facility control system 100 may monitor a production facility 102. The production facility 102 may include equipment 104. The equipment 104 may include any equipment that may be utilized at an oil and gas production facility. For example, the equipment 104 may include one or more of compressors, pumps, separation units, degasification units, purification units, heat exchangers, heaters, chillers, mol sieves, dehydrators, destalters, boilers, contactors, distillation columns, membranes, filters, any other equipment, and combinations thereof. While embodiments of the present disclosure may be related to specific types of equipment, such compressors or banks of compressors in series or in parallel, it should be understood that the techniques of the present disclosure may be applied to any unit or type of equipment.

The production facility control system 100 may further include an equipment controller 106. The equipment controller 106 may be in communication with the equipment 104 in the production facility 102. For example, the equipment controller 106 may be in communication with the equipment 104 to change the operating status of the equipment 104. The equipment controller 106 may change the operating parameters of the equipment 104, such as the various settings, positioning, or other operating parameters of the equipment 104. In some examples, the equipment controller 106 may change whether a particular unit of equipment 104 is turned on or shut down. As a specific, non-limiting example, the equipment controller 106 may change the compressor settings of a compressor, such as the output pressure.

The production facility control system 100 may include a predictive control manager 108. The predictive control manager 108 may be in communication with the production facility 102, including with various units of equipment 104 of the production facility 102, and the equipment controller 106. For example, the elements of the production facility control system 100 may be in communication over a network 110, such as the Internet. In some embodiments, the user may communicate with elements of the production facility control system 100 over the network 110 via a user device 112.

The predictive control manager 108 may include multiple predictive controllers (collectively 114). The predictive control manager 108 may receive inputs from the production facility 102 and/or the equipment controller 106 regarding the operating status of the equipment 104. In some embodiments, the predictive control manager 108 may receive the inputs directly from the production facility 102. In some embodiments, the predictive control manager 108 may receive the inputs from the equipment controller 106 and/or over the network 110. The inputs received by the predictive control manager 108 may include any inputs. For example, the predictive control manager 108 may receive inputs related to a facility input to the production facility 102 (e.g., oil and/or gas input volume, composition, etc.). In some examples, the predictive control manager 108 may receive inputs related to the operating status of the equipment 104 of the production facility 102. In some examples, the inputs received by the predictive control manager 108 may include a current operating state of the production facility 102. In some embodiments, the predictive control manager 108 may generate the current operating state of the production facility 102 using the inputs. The predictive control manager 108 may include a facility model that may be used to model the current operating state.

In accordance with at least one embodiment of the present disclosure, the predictive control manager 108 may receive an input associated with a change in the operating state of the production facility 102. For example, the predictive control manager 108 may receive an input identifying that the facility input of an input stream of oil and/or gas has changed or will change. The predictive control manager 108 may identify a target operating state based on the change to the facility input. The target operating state may include any level of detail of the operating state of the production facility 102. For example, the target operating state may include a low-level of detail, such as the changed facility input and/or requested facility outputs of the production facility 102. In some examples, the target operating state may include a particular combination of units of equipment operating, or a particular operating status for one or more units of equipment.

As a specific, non-limiting example, the production facility 102 and/or an operator may identify that the production facility 102 may receive in increase in the volume of gas input as a facility input. The predictive control manager 108 may identify that the gas input may increase. The predictive control manager 108 may identify the target operating state as an operating state that may process the gas input at a desired level of efficiency. In some embodiments, the predictive control manager 108 may identify that the target operating state is one that is capable of processing the change in input gas volume. In some embodiments, the predictive control manager 108 may identify the target operating state as the number of units of equipment 104 that are turned on and their associated operating status.

The predictive control manager 108 may include predictive controllers 114 that may estimate one or more pathways to transition the production facility 102 from the current operating state to the target operating state. The predictive controllers 114 may generate a transitionary operating state for the production facility 102. The transitionary operating state may be the first change or first changes to the current operating state on a pathway to the target operating state. The transitionary operating state may be selected based on the pathway that has the lowest carbon dioxide emissions. The predictive control manager 108 may select the transitionary operating state based on which of the pathways identified by the predictive controllers 114 has the lowest carbon dioxide emissions. The predictive control manager 108 may then provide the recommendation of the selected transitionary operating state to an operator (e.g., to the user device 112) and/or instruct the equipment controller 106 to change the operating state of the production facility 102 from the current operating state to the selected transitionary operating state. In this manner, the predictive control manager 108 may facilitate the transition from the current operating state to the target operating state while reducing carbon dioxide emissions.

The predictive controllers 114 of the predictive control manager 108 may have different focuses or layers of control. As a specific, non-limiting example, the predictive control manager 108 may include a first predictive controller 114-1 and a second predictive controller 114-2. The second predictive controller 114-2 may be a local controller. For example, the second predictive controller 114-2 may predict and recommend changes to the operating state of the production facility 102 based on which equipment 104 is operating in the current operating state. The second predictive controller 114-2 may prepare recommendations to increase the efficiency of operation of the equipment 104 by changing the operating status of the equipment 104 without turning on or shutting down any particular units of equipment. As discussed herein, the second predictive controller 114-2 may be configured to optimize production by reducing carbon dioxide emissions, and the second predictive controller 114-2 may prepare an estimated second carbon dioxide emissions associated with the second pathway.

In some embodiments, the first predictive controller 114-1 may be a supervisory controller. For example, the first predictive controller 114-1 may estimate pathways to the target operating state based on turning on or shutting down one or more units of the equipment 104. As a specific, non-limiting example, the facility input may be changed by increasing the volume of gas input. The first predictive controller 114-1 may generate a pathway to the target operating state based on turning on additional compressors or banks of compressors. As discussed herein, the first predictive controller 114-1 may be configured to optimize production by reducing carbon dioxide emissions, and the first predictive controller 114-1 may prepare an estimated first carbon dioxide emissions associated with the first pathway.

The predictive control manager 108 may receive first transitionary state and the second transitionary state, including the associated carbon dioxide emissions. The predictive control manager 108 may select, based on the carbon dioxide emissions, which of the transitionary operating states to implement at the production facility 102. In this manner, the predictive control manager 108 may generate a recommendation to transition the production facility 102 from the current operating state to the target operating state and reduce carbon dioxide emissions.

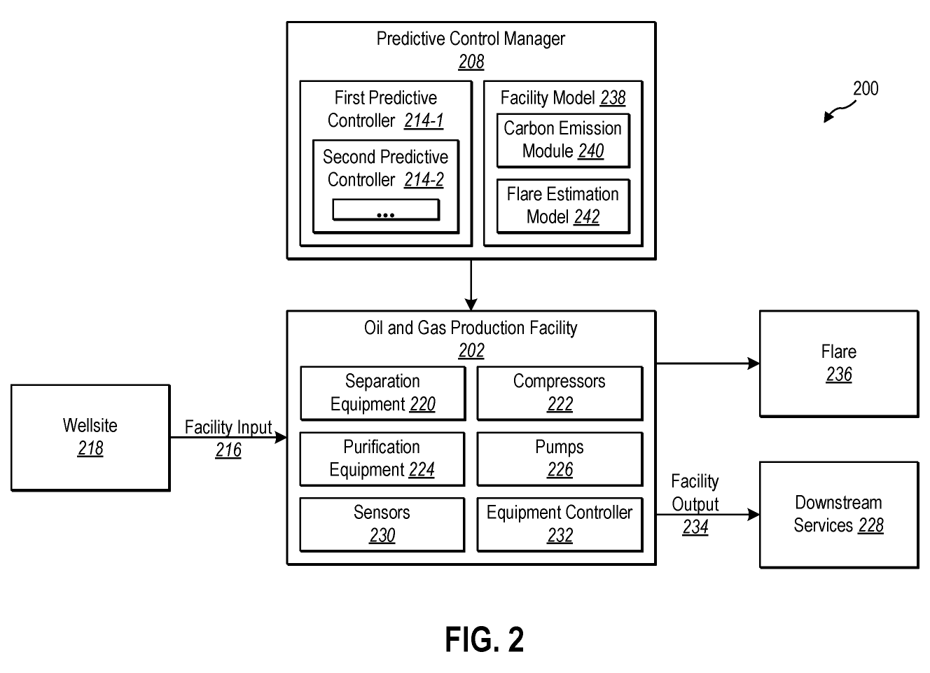

FIG. 2 is a schematic representation of a production facility control system 200, according to at least one embodiment of the present disclosure. In the production facility control system 200, an oil and gas production facility 202 (also referred to herein as a production facility 202) may receive a facility input 216 from a wellsite 218. The wellsite 218 may include one or more wells that produce a crude oil stream. In some embodiments, the facility input 216 may be acquired from a collection facility that may collect the crude oil from one or more wells that are remote from each other.

The facility input 216 may include crude oil. For example, the facility input 216 may include unprocessed oil as received from the well. In some examples, the crude oil may be at least partially processed with one or more chemical additives to improve the processing and transportation of the crude oil, such as certain paraffin inhibitors, scale inhibitors, anti-agglomerant hydrate inhibitors, or other inhibitors that may facilitate the transportation of the crude oil from the well to the production facility 202. In some embodiments, the facility input 216 may include a gas input. For example, the wellsite 218 may include a natural gas well and transmit the natural gas to the production facility. In some embodiments, the facility input 216 may include a combination of oil and gas. In some embodiments, the facility input 216 may be at least partially processed. For example, the facility input 216 may be a gas stream including hydrocarbon gas that has been separated from a crude oil.

The production facility 202 may process the facility input 216 using one or more of the equipment discussed herein. It should be understood that the equipment discussed with respect to the production facility 202 are exemplary facility equipment, and that a production facility 202 may include any combination of one or more of the equipment discussed herein, with specific equipment included or excluded based on the layout of the production facility 202 and the anticipated composition of the facility input 216.

In accordance with at least one embodiment of the present disclosure, the production facility 202 may include separation equipment 220 that may separate the components of the facility input 216. For example, the separation equipment 220 may separate the oil and water phases of the facility input 216, extract gas from the facility input 216, extract solids from the facility input 216, or otherwise separate components from the facility input 216 based on the composition of the facility input 216 and the other equipment in the production facility 202. In some examples, the separation equipment 220 may separate a natural gas throughput into different gasses, such as methane, ethane, propane, and so forth.

The production facility 202 may further include one or more compressors 222. The compressors 222 may receive a gas portion of the facility input 216 and compress the gas portion for transportation, storage, or other processing. The compressors 222 may be arranged in series, with different compressors 222 increasing the pressure incrementally to a target pressure. In some embodiments, the compressors 222 may be arranged in parallel. In some embodiments, the compressors 222 may include one or more compressor sets. A compressor set may include a set of compressors 222 that are arranged in series or in parallel to process a certain throughput of gas. For example, a compressor set may include two or more compressors in series to compress the throughput of gas to the target pressure. Multiple compressor sets may be arranged in parallel to increase the total throughput of gas processed by the compressors 222. In some embodiments, the compressors 222 may include or be associated with a gas pipeline pumping station.

The production facility 202 may further include purification equipment 224. The purification equipment 224 may purify the content of the oil and/or gas in the production facility 202. For example, the purification equipment 224 may include removal systems for various gasses, such as sulfur dioxide, carbon dioxide, carbon monoxide, oxygen, nitrogen, or other gasses.

The production facility 202 may further include one or more pumps 226. The pumps 226 may pump fluid around the production facility 202 and/or out of the production facility 202 to various downstream services 228. In some embodiments, the pumps 226 may be liquid pumps configured or designed to pump liquids, including liquid oil, gas, or a combination of liquid oil and gas. In some embodiments the pumps 226 may be configured to transport gas, including blowers, fans, compressors, or other elements configured to facilitate transportation of gas in the production facility 202 and/or to the downstream services 228.

The production facility 202 may include one or more sensors 230. The sensors 230 may sense the status of the various equipment of the production facility 202, including input parameters, operating parameters, pressures, temperatures, chemical composition, flow rates, and so forth.

An equipment controller 232 may be in communication with the equipment of the production facility 202. The equipment controller 232 may make control changes to operating parameters of the equipment. For example, the equipment controller 232 may turn on equipment, turn off equipment, change motor settings, open and close valves, change temperatures, control any other aspect of the equipment, and combinations thereof.

The production facility 202 may process the facility input 216 and generate a facility output 234. The facility output 234 may be directed to the various downstream services 228. The various downstream services 228 may include any type of downstream service, such as a refinery, a power plant, directly to consumers, any other various downstream service 228, and combinations thereof. In some embodiments, excess gas, or gas that is unable to be processed by the production facility 202, may be burnt off at a flare 236.

Operation of the production facility 202 may result in carbon dioxide emissions. For example, the operation of the separation equipment 220, the compressors 222, the purification equipment 224, the pumps 226, and other equipment, may consume electricity. The electricity may be generated using fossil fuels or other carbon dioxide-generating methods. In some embodiments, the electricity may be grid electricity generated at a remote power generation plant. In some embodiments, the electricity may be generated using on-site generators, including diesel, gasoline, or natural gas powered generators. The flare 236 may include point-source carbon dioxide emissions as a result of burning excess gas from the production facility 202.

The operating state of the production facility 202 may be based, at least in part, on the facility input 216. For example, the operating state of the production facility 202 may be based on the volumetric or mass flow rate of the facility input 216. For example, for a facility input 216 including gas, a certain number of compressors 222 may be utilized to compress and otherwise process the input gas.

In some situations, the facility input 216 may be variable. For example, the volumetric or mass flow rate of the facility input 216 may vary. The facility input 216 may vary for any reason, such as based on production rates at the wellsite 218, purchase price of the facility input 216, consumer demand, and so forth. When the facility input 216 changes, the operating state of the production facility 202 may change. For example, an increase in the flow rate of the facility input 216 may cause additional equipment to come online to accommodate the higher flow rate, such as additional compressors 222 or additional compressor sets.

As discussed herein, when the facility input 216 changes, the production facility control system 200 may identify a target operating state to accommodate the facility input 216. The transition between the current operating state (as defined by the old facility input 216 and/or measured by the one or more sensors 230) and the target operating state (as indicated by the new facility input 216) may occur over a transition period. During the transition period, new equipment may be turned on, turned off, or otherwise change operating status to accommodate the new facility input 216. Such changes may result in operating inefficiencies in the equipment. These operating efficiencies may result in increased carbon dioxide emissions.

The change in the operating status may include any change. For example, the production facility 202 may be shut down, and the change in the operating status may include resuming operation of the production facility 202. In some examples, the production facility 202 may be operating, and the change in operating status may include shutting down the production facility 202. In some examples, the production facility 202 may be operating, and the change in operating status may include an increase in the facility input 216, resulting in an increase in the number of equipment turned on (e.g., a decrease in the number of equipment turned off). In some examples, the production facility 202 may be operating, and the change in operating status may include a decrease in the facility input 216, resulting in a decrease in the number of equipment turned on (e.g., an increase in the number of equipment turned off).

In accordance with at least one embodiment of the present disclosure, the production facility control system 200 may include a predictive control manager 208. The predictive control manager 208 may receive or identify the operating state of the production facility 202. For example, the predictive control manager 208 may receive one or more measurements from the sensors 230 and use the measurements to identify the operating state of the production facility 202. In some examples, the predictive control manager 208 may receive an indication of the facility input 216, including the flow rate of the facility input 216, and identify or infer an operating state of the production facility 202 based on the facility input 216.

In some examples, the predictive control manager 208 may include a facility model 238. The facility model 238 may receive the facility input 216 and/or equipment status measurements from the sensors 230 of one or more operating parameters of the equipment of the production facility 202. The facility model 238 may determine or generate the operating state of the production facility 202 based on the received facility input 216 and/or equipment status measurements from the sensors 230.

As discussed herein, the facility model 238 may generate different operating states of the production facility 202 based on the received inputs. For example, the facility model 238 may generate a current operating state based on current or up-to-date measurements from the sensors 230. In some examples, the facility model 238 may generate a target operating state based on a change in the facility input 216 with which the production facility 202 has not caught up yet. In some embodiments, the target operating state may include a comparison between the current operating state and the equipment that is to be operating to process the change in the facility input 216.

The facility model 238 may include a carbon emission module 240. The carbon emission module 240 may identify carbon dioxide emissions based on the operating state of the production facility 202. The carbon emission module 240 may identify carbon dioxide emissions in any manner. For example, the carbon emission module 240 may identify carbon dioxide emissions based on direct emissions, such as emissions by a fossil fuel generator on site, the emissions caused by the flare 236, or other direct emissions. In some examples, the carbon emission module 240 may identify carbon dioxide emissions indirectly. For example, the carbon emission module 240 may identify carbon dioxide emissions based on electricity consumption by the equipment of the production facility 202, the power source of grid electricity powering the production facility 202, and the carbon emissions from the power source to generate the power.

In some embodiments, the carbon emission module 240 may identify carbon dioxide emissions based on the current operating state. For example, the carbon emission module 240 may identify, at a particular point in time, the carbon dioxide emissions emitted by or caused by operation of the production facility 202. In some embodiments, the carbon emission module 240 may identify carbon dioxide emissions based on the target operating state. For example, the target operating state may include a certain combination of equipment that may operate to process the change in the facility input 216, and the carbon emission module 240 may identify the carbon dioxide emissions based on this combination of equipment.

The predictive control manager 208 may further include a flare estimation model 242. The flare estimation model 242 may estimate the amount of gas burned at the flare 236 based on the facility input 216 and the throughput of the production facility 202. The carbon emission module 240 may estimate the carbon dioxide emissions from the flare 236 based on the flare estimation model 242. In some embodiments, the flare estimation model 242 may estimate the amount of gas flared at the flare 236 at the target operating state, which the carbon emission module 240 may utilize to identify the carbon dioxide emissions at the target operating state.

The predictive control manager 208 may include multiple predictive controllers (collectively 214). As discussed herein, the predictive controllers 214 may provide recommendations and/or instructions to the equipment controller 232 to adjust operation of the production facility 202 based on one or more factors. For example, the predictive controllers 214 may provide recommendations to transition the production facility 202 to the target operating state. The predictive controllers 214 may provide recommendations to transition the production facility 202 to the target operating state based on reducing the carbon dioxide emissions.

In accordance with at least one embodiment of the present disclosure, the predictive control manager 208 may include a first predictive controller 214-1 and a second predictive controller 214-2. The second predictive controller 214-2 may be a local controller, which may provide recommendations to change the operating parameters of currently operating equipment. The first predictive controller 214-1 may be a supervisory controller, which may provide recommendations to turn on or turn off equipment to transition to the target operating state. While embodiments of the present disclosure explicitly discuss two predictive controllers 214, it should be understood that additional layers of predictive controllers 214 may be provided. For example, different equipment lines may include their own controllers. In some examples, different inputs or outputs may have different controllers. This may facilitate flexibility in generating recommendations to reduce carbon dioxide emissions.

The predictive controllers 214 may access the facility model 238 to estimate how changes in the operating status or operating parameters of the equipment of the production facility 202 may impact the operating state of the production facility 202. For example, the second predictive controller 214-2 may include or access the facility model 238, including the carbon emission module 240 and the flare estimation model 242, to estimate how changes in the operating status of the equipment may change the carbon dioxide emissions of the production facility 202. In some examples, the first predictive controller 214-1 may include or access the facility model 238, including the carbon emission module 240 and the flare estimation model 242, to estimate how changes in which equipment are turned on or shut down may impact the carbon dioxide emissions of the production facility 202.

The predictive controllers 214 may each provide a pathway to transition the production facility 202 from the current operating state to the target operating state. The pathway may include one or more transitionary operating states between the current operating state and the target operating state. The transitionary operating states may include at least one change in the operating status of the equipment and/or a change in a unit of equipment that has been turned on or turned off. In some embodiments, the pathway may include multiple step-wise changes to transition the production facility 202 from the current operating state to the target operating state.

The predictive controllers 214 may estimate the total carbon dioxide emissions (e.g., cumulative carbon emissions) to transition the production facility 202 to the target operating state based on each transitionary operating state identified on the generated pathway. For example, the predictive controllers 214 may generate the pathway by iteratively estimating a change to the production facility 202, applying the facility model 238 to the change to generate a transitionary operating state, analyzing the transitionary operating state, providing a new change to the transitionary operating state, applying the facility model 238 to the new change, and generating a new transitionary operating state. The facility model 238 may identify the carbon dioxide emissions at each transitionary operating state between the current operating state and the target operating state. The predictive controllers 214 may iteratively generate changes identify the transitionary states to generate the pathway. Each transitionary operating state in the pathway may be made based on reducing the carbon dioxide emissions. In some embodiments, each transitionary operating state may be modeled by the facility model 238 repeatedly to minimize the carbon dioxide emissions at that step. In some embodiments, the predictive controllers 214 may generate the pathway until the facility model 238 simulates that a change results in the target operating state. In some embodiments, the predictive controllers 214 may generate the pathway based on another metric, such as based on the receding horizon, a number of steps, or other metric.

The total of the carbon dioxide emissions at each transitionary operating state may be the cumulative carbon emissions. The first predictive controller 214-1 may generate first cumulative carbon emissions to reach the target operating state using the constraints of the first predictive controller 214-1 discussed herein. The second predictive controller 214-2 may generate second cumulative carbon emissions to reach the target operating state using the constraints of the second predictive controller 214-2 discussed herein.

Each of the predictive controllers 214 may generate a pathway. Each pathway may include multiple steps of transitionary operating states and associated carbon dioxide emissions. The predictive control manager 208 may identify which of the pathways has the lowest carbon dioxide emissions. For example, the predictive control manager 208 may receive a first pathway from the first predictive controller 214-1 having first carbon dioxide emissions and a second pathway from the second predictive controller 214-2 having second carbon dioxide emissions. The predictive control manager 208 may select the first pathway or the second pathway based on which of the first carbon dioxides or the second carbon dioxide emissions are lower. The predictive control manager 208 may then provide the recommendation to the user and/or provide an instruction to the equipment controller 232 to implement the first step along the path, or by causing the recommended changes to transition the production facility 202 to the associated transitionary state.

The production facility 202 may implement the recommended or selected transitionary operating state. For example, the equipment controller 232 may cause the changes in the equipment of the production facility 202 that will transition the equipment of the production facility 202 to the selected transitionary state.

While in the transitionary state, the predictive control manager 208 may cause the predictive controllers 214 to generate new pathways. For example, based on the transitionary operating state, the predictive controllers 214 may generate new pathways including new transitionary operating states with associated new carbon dioxide emissions. The predictive control manager 208 may select the new transitionary operating state based on which of the new carbon dioxide emissions are lower. The first pathway or the second pathway may have lower carbon dioxide emissions at different transitionary states. In this manner, the predictive control manager 208 may identify when to turn on or turn off equipment and when to change operating parameters of the equipment of the production facility 202 to reduce carbon dioxide emissions during transitionary periods.

In some embodiments, one of the predictive controllers 214 may not be capable of generating a pathway that reaches the target operating state based on the constraints of the predictive controller 214. For example, the currently operating equipment may not have the capacity or throughput to accommodate an increase in the facility input 216. In this case, the first predictive controller 214-1 may generate a pathway to reduce the operating carbon dioxide emissions using the existing equipment. When a new unit of equipment is turned on (e.g., through the selection of a pathway or transitionary operating state from the second predictive controller 214-2), the first predictive controller 214-1 may generate a pathway to reduce the carbon dioxide emissions of the currently operating equipment (including the newly turned on unit), such as by increasing the operating load on the unit of equipment until it is operating within a desired efficiency range. In some examples, when a unit of equipment is turned off (e.g., through the selection of a pathway or transitionary operating state from the second predictive controller 214-2), the first predictive controller 214-1 may generate a pathway to reduce the carbon dioxide emissions of the remaining operating equipment, such as by decreasing the operating load on one or more units of equipment until they are operating within a desired efficiency range. When the currently operating equipment are operating within the desired efficiency range and/or the pathway to the desired efficiency range will exceed a time setpoint to transition to the target operating state, the second predictive controller 214-2 may provide a recommendation or cause one or more of the currently operating equipment to turn on or off to move closer to the target operating state. In this manner, the first predictive controller 214-1 and the second predictive controller 214-2 may cooperate to balance carbon dioxide emissions for currently operating equipment and carbon dioxide emissions during the transition to the target operating state.

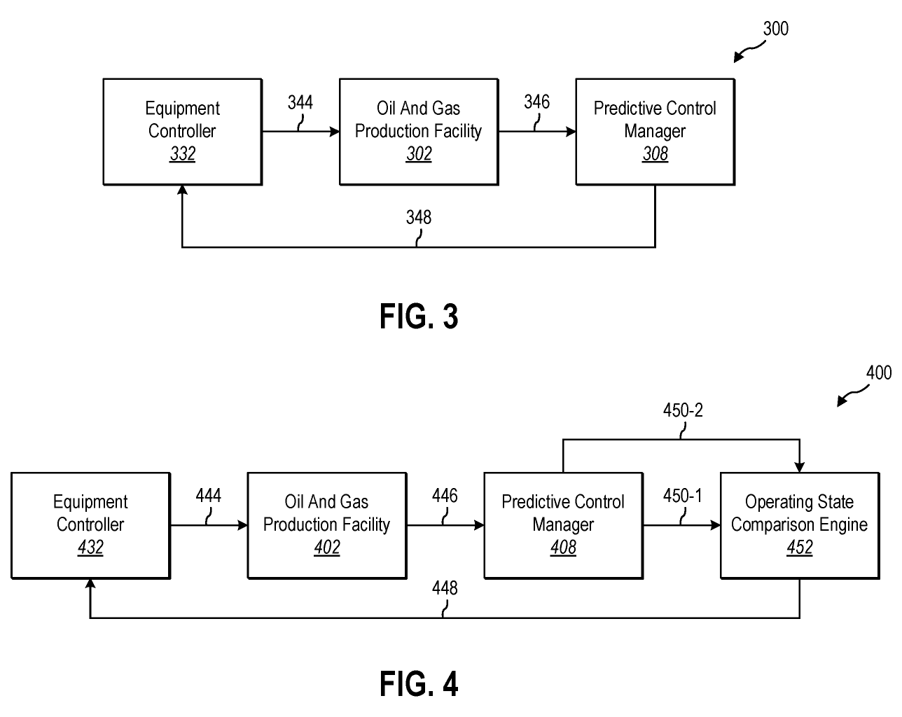

FIG. 3 is a representation of a flow diagram of a production facility control system 300, according to at least one embodiment of the present disclosure. An equipment controller 332 may provide control signals 344 to a production facility 302. The production facility 302 may include equipment, and the control signals 344 may cause a change in the operating parameters of the equipment.

The production facility 302 may have an operating state. The production facility 302 may provide the operating state 346 to a predictive control manager 308. The production facility 302 may provide the operating state 346 to the predictive control manager 308 in any manner. For example, the production facility 302 may provide a representation of the inputs and outputs of the production facility 302 to the predictive control manager 308. In some examples, the production facility 302 may provide sensor measurements of the operating status of various units of equipment in the production facility 302 to the predictive control manager 308. As discussed herein, in some embodiments, the production facility 302 may provide a change in the operating state, or a target operating state to the predictive control manager 308.

The predictive control manager 308 may analyze the operating state 346 and the target operating state. The predictive control manager 308 may generate multiple pathways to transition the production facility 302 from the current operating state to the target operating state. The predictive control manager 308 may generate the pathways to transition to the target operating state to reduce carbon dioxide emissions. For example, the predictive control manager 308 may generate a first pathway with a first transitionary state to change the operating parameters of currently operating equipment, with associated first carbon dioxide emissions. The predictive control manager 308 may generate a second pathway with a second transitionary state that includes turning on or shutting down one or more units of equipment to reach the target operating state. The predictive control manager 308 may then select the pathway that has the lower carbon dioxide emissions. Based on the selected pathway and transitionary operating state, the predictive control manager 308 may provide a control instruction 348 to the equipment controller 332, which may then control a change in the operating parameters of the production facility 302 based on the control instruction 348.

After the change in the operating parameters and transition to the transitionary operating state, the production facility 302 may provide a new operating state 346 to the predictive control manager 308, and the predictive control manager 308 may generate a new control instruction 348 based on the new operating state 346. In this manner, and as may be seen, the production facility control system 300 may result in a control loop that may cause the production facility 302 to transition to the target operating state with reduced carbon dioxide emissions.

FIG. 4 is a representation of a flow diagram of a production facility control system 400, according to at least one embodiment of the present disclosure. An equipment controller 432 may provide control signals 444 to a production facility 402. The production facility 402 may include equipment, and the control signals 444 may cause a change in the operating parameters of the equipment. The production facility 402 may have an operating state. The production facility 402 may provide the operating state 446 to a predictive control manager 408. The production facility 402 may provide the operating state 446 to the predictive control manager 408 in any manner.

The predictive control manager 408 may analyze the operating state 446 and the target operating state. The predictive control manager 408 may generate multiple pathways to transition the production facility 402 from the current operating state to the target operating state. For example, the predictive control manager 408 may generate a first pathway 450-1 based on reducing carbon dioxide emissions for an existing set of equipment and a second pathway 450-2 based on reducing carbon dioxide emissions while adding or removing equipment.

An operating state comparison engine 452 may receive the first pathway 450-1 and the second pathway 450-2 and compare their respective carbon dioxide emissions. The operating state comparison engine 452 may select the pathway 450 having the lowest carbon dioxide emissions to reach the target operating state. The operating state comparison engine 452 may prepare a control instruction 448 based on the selected pathway. For example, the control instruction 448 may include a recommendation to change the operating parameters of one or more units of equipment in the production facility 402 to the first transitionary operating state of the selected pathway 450. The equipment controller 432 may provide a control signal 444 to change the operating parameters of the production facility 402 based on the control instruction 448. As discussed herein, this process may be repeated until the production facility 402 reaches the target operating state.

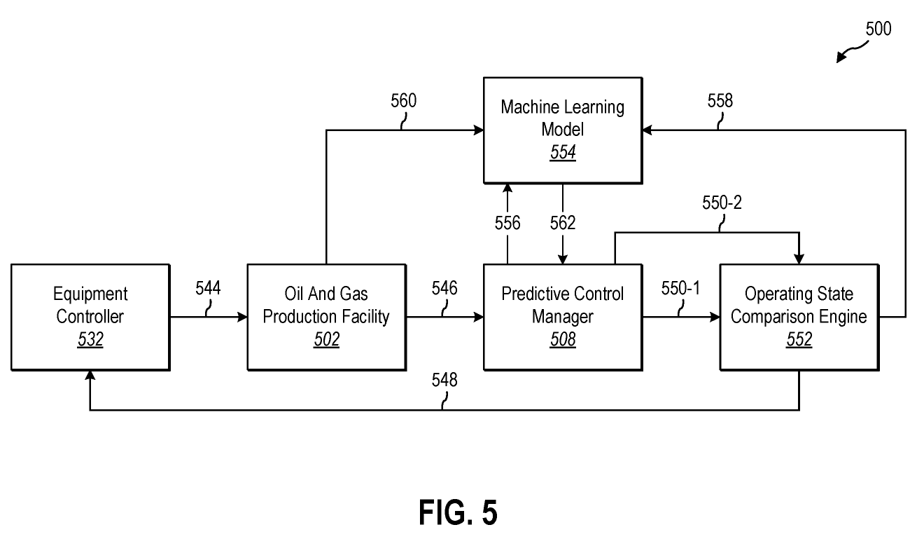

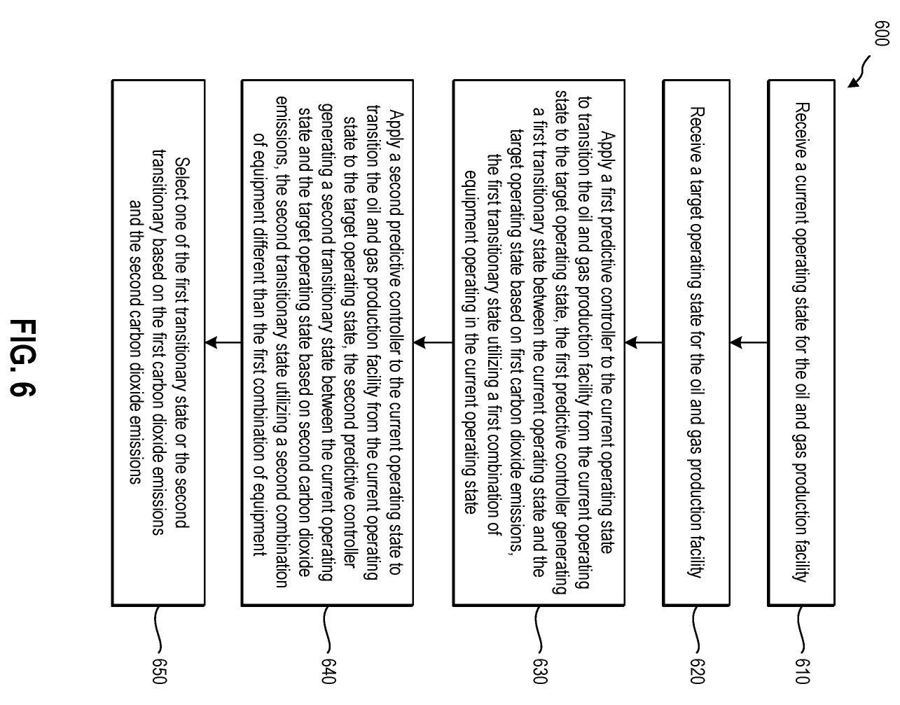

FIG. 5 is a representation of a flow diagram of a production facility control system 500, according to at least one embodiment of the present disclosure. An equipment controller 532 may provide control signals 544 to a production facility 502. The production facility 502 may include equipment, and the control signals 544 may cause a change in the operating parameters of the equipment. The production facility 502 may have an operating state. The production facility 502 may provide the operating state 546 to a predictive control manager 508. The production facility 502 may provide the operating state 546 to the predictive control manager 508 in any manner.

The predictive control manager 508 may analyze the operating state 546 and the target operating state. The predictive control manager 508 may generate multiple pathways to transition the production facility 502 from the current operating state to the target operating state. For example, the predictive control manager 508 may generate a first pathway 550-1 based on reducing carbon dioxide emissions for an existing set of equipment and a second pathway 550-2 based on reducing carbon dioxide emissions while adding or removing equipment.

An operating state comparison engine 552 may receive the first pathway 550-1 and the second pathway 550-2 and compare their respective carbon dioxide emissions. The operating state comparison engine 552 may select the pathway 550 having the lowest carbon dioxide emissions to reach the target operating state. The operating state comparison engine 552 may prepare a control instruction 548 based on the selected pathway. For example, the control instruction 548 may include a recommendation to change the operating parameters of one or more units of equipment in the production facility 502 to the first transitionary operating state of the selected pathway 550. The equipment controller 532 may provide a control signal 544 to change the operating parameters of the production facility 502 based on the control instruction 548.

In accordance with at least one embodiment of the present disclosure, the production facility control system 500 may include a machine learning model 554. The machine learning model 554 may be trained to improve the predictions of the predictive control manager 508. For example, the machine learning model 554 may receive control data 556 from the predictive control manager 508, selection data 558 from the operating state comparison engine 552, and operations data 560 from the production facility 502. The machine learning model 554 may include a predictive controller, facility model, or other component production facility control systems discussed herein that may be trained using machine learning methods to improve predictions and recommendations of the production facility control system 500.

For example, the machine learning model 554 may receive the control data 556 including the first pathway 550-1, the second pathway 550-2, and their associated predicted emissions and transitionary operating states. The machine learning model 554 may receive the selection data 558, including the reason that the operating state comparison engine 552 chose the selected pathway 550 and the control instruction 548 provided to the equipment controller 532. The machine learning model 554 may then receive operations data 560 from the production facility 502. The operations data 560 may include the operating state, the operating status of the various equipment of the production facility 502, carbon emissions resulting from the operation of the production facility 502, and so forth. The machine learning model 554 may analyze the predicted carbon dioxide emissions, the actual carbon dioxide emissions, and the impact of the control instruction 548 on the production facility 502. The machine learning model 554 may provide adjustments or alterations to the predictive control manager 508 to adjust the analysis and recommendations of the 508, including the predictive controllers and facility models in the predictive control manager 508. In this manner, the machine learning model 554 may be used to fine-tune the predictive control manager 508, including the predictive controllers and the facility models used by the predictive control manager 508. This may further improve the predictive capacities of the production facility control system 500, which may further reduce carbon dioxide emissions during transition to the target operating state.

As used herein, the term “machine learning” refers to algorithms that generate data-driven predictions or decisions from known input data by modeling high-level abstractions. Examples of machine-learning models include computer representations that are tunable (e.g., trainable) based on inputs to approximate unknown functions. For instance, a machine-learning model includes a model that utilizes algorithms to learn from, and make predictions on, known data by analyzing the known data to learn to generate outputs that reflect patterns and attributes of the known data. For example, machine-learning models include latent Dirichlet allocation (LDA), multi-arm bandit models, linear regression models, classification models, logistical regression models, random forest models, support vector machines (SVMs) models, neural networks (convolutional neural networks, recurrent neural networks such as LSTMs, graph neural networks, etc.), or decision tree models.

A machine learning model may be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning model may include one or multiple machine learning models that cooperatively generate one or more outputs based on corresponding inputs.

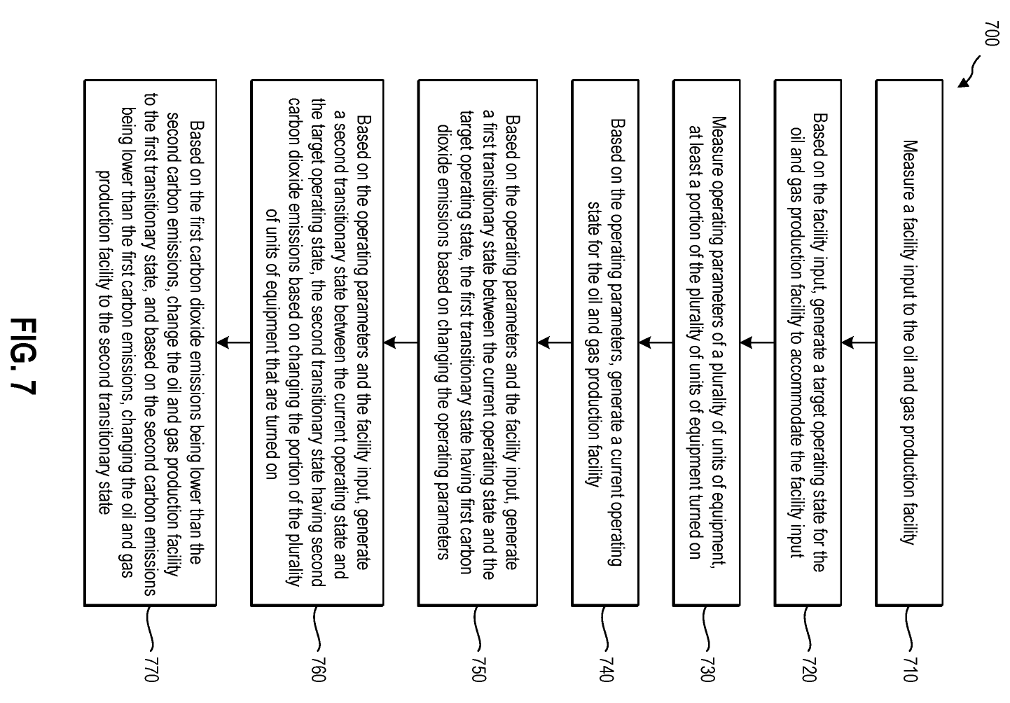

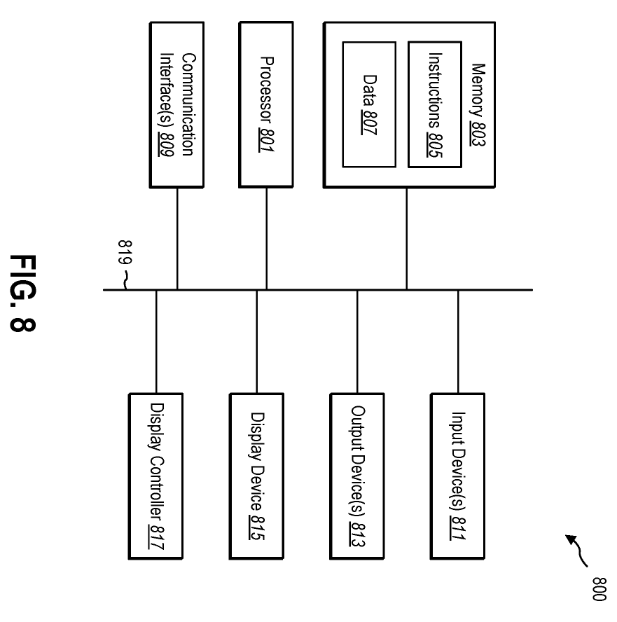

FIGS. 6 and 7, the corresponding text, and the examples provide a number of different methods, systems, devices, and computer-readable media of the production facility control system. In addition to the foregoing, one or more embodiments can also be described in terms of flowcharts comprising acts for accomplishing a particular result, as shown in FIGS. 6 and 7. FIGS. 6 and 7 may be performed with more or fewer acts. Further, the acts may be performed in differing orders. Additionally, the acts described herein may be repeated or performed in parallel with one another or parallel with different instances of the same or similar acts.

As mentioned, FIG. 6 illustrates a flowchart of a series of acts or a method for changing operating state at an oil and gas production facility to reduce carbon dioxide emissions, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

A predictive control manager may receive a current operating state for the oil and gas production facility at 610. The predictive control manager may receive a target operating state for the oil and gas production facility at 620. The predictive control manager may apply a first predictive controller to the current operating state to transition the oil and gas production facility from the current operating state to the target operating state at 630. The first predictive controller generates a first transitionary state between the current operating state and the target operating state based on first carbon dioxide emissions. The first transitionary state utilizes a first combination of equipment operating in the current operating state.

The predictive control manager applies a second predictive controller to the current operating state to transition the oil and gas production facility from the current operating state to the target operating state at 640. The second predictive controller generates a second transitionary state between the current operating state and the target operating state based on second carbon dioxide emissions. The second transitionary state utilizes a second combination of equipment different than the first combination of equipment. The predictive control manager selects one of the first transitionary state or the second transitionary based on the first carbon dioxide emissions and the second carbon dioxide emissions at 650.

As mentioned, FIG. 7 illustrates a flowchart of a series of acts or a method for changing operating state at an oil and gas production facility to reduce carbon dioxide emissions, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

A production facility control system measures a facility input to the oil and gas production facility at 710. The production facility control system generates a target operating state for the oil and gas production facility to accommodate the facility input at 720. The production facility control system measures operating parameters of a plurality of units of equipment, at least a portion of the plurality of units of equipment turned on at 730. The production facility control system, based on the operating parameters, generates a current operating state for the oil and gas production facility at 740.

The production facility control system, based on the operating parameters and the facility input, generates a first transitionary state between the current operating state and the target operating state at 750. The first transitionary state has first carbon dioxide emissions based on changing the operating parameters. The production facility control system, based on the operating parameters and the facility input, generates a second transitionary state between the current operating state and the target operating state at 760. The second transitionary state has second carbon dioxide emissions based on changing the portion of the plurality of units of equipment that are turned on. The production facility control system, based on the first carbon dioxide emissions being lower than the second carbon emissions, changes the oil and gas production facility to the first transitionary state and based on the second carbon emissions being lower than the first carbon emissions, changes the oil and gas production facility to the second transitionary state at 770.

FIG. 8 illustrates certain components that may be included within a computer system 800. One or more computer systems 800 may be used to implement the various devices, components, and systems described herein.

The computer system 800 includes a processor 801. The processor 801 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth^{®} wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method implemented at an oil and gas production facility operating at a current operating state, the method comprising:
applying a first predictive controller to the current operating state to generate a first transitionary state between the current operating state and a target operating state, the first transitionary state utilizing a first combination of equipment operating in the current operating state and resulting in first carbon dioxide emissions;
applying a second predictive controller to the current operating state to generate a second transitionary state between the current operating state and the target operating state, the second transitionary state utilizing a second combination of equipment different than the first combination of equipment and resulting in second carbon dioxide emissions; and
selecting one of the first transitionary state or the second transitionary based on the first carbon dioxide emissions and the second carbon dioxide emissions.

2. The method of claim 1, further comprising:
receiving sensor measurements of existing equipment operating in the current operating state; and
applying a facility model to the sensor measurements to predict system dynamics.

3. The method of claim 2, wherein applying the facility model includes applying a carbon emission model to the target operating state to predict the first carbon dioxide emissions and the second carbon dioxide emissions.

4. The method of claim 3, wherein applying the carbon emission model includes identifying an electricity consumption of the first combination of equipment and the second combination of equipment and associating the electricity consumption with an electricity source.

5. The method of claim 1, wherein generating the second transitionary state includes at least one of starting a new unit of equipment or stopping a unit of equipment.

6. The method of claim 1, wherein selecting the one of the first transitionary state or the second transitionary state includes:
selecting the first transitionary state based on the first carbon dioxide emissions being lower than the second carbon dioxide emissions; and
selecting the second transitionary state based on the second carbon dioxide emissions being lower than the first carbon dioxide emissions.

7. The method of claim 1, wherein the first carbon dioxide emissions are first cumulative carbon emissions to reach the target operating state and the second carbon dioxide emissions are second cumulative carbon emissions to reach the target operating state.

8. The method of claim 1, wherein the target operating state includes shutting down the oil and gas production facility.

9. The method of claim 1, wherein the first carbon dioxide emissions and the second carbon dioxide emissions include carbon emissions from a gas flare.

10. The method of claim 1, further comprising implementing the one of the first transitionary state or the second transitionary state in the oil and gas production facility.

11. The method of claim 1, wherein the first predictive controller generates a first pathway between the current operating state and the target operating state, the first transitionary state including at least one step on the first pathway, and wherein the second predictive controller generates a second pathway between the current operating state and the target operating state, the second transitionary state including at least one step on the first pathway.

12. The method of claim 11, wherein the first transitionary state and the second transitionary are a first step on the first pathway and the second pathway.

13. A method implemented at an oil and gas production facility, the method comprising:
generating a target operating state for the oil and gas production facility to accommodate a facility input;
generating a current operating state for the oil and gas production facility based on operating parameters measured at a plurality of units of equipment;
generating a first transitionary state and a second transitionary state between the current operating state and the target operating state, the first transitionary state having first carbon dioxide emissions based on changing the operating parameters and the second transitionary state having second carbon dioxide emissions based on changing a portion of the plurality of units of equipment that are turned on;
changing the oil and gas production facility to the first transitionary state or the second transitionary state using the first carbon dioxide emissions and the second carbon dioxide emissions.

14. The method of claim 13, further comprising measuring the operating parameters including an electricity consumption of the plurality of units of equipment.

15. The method of claim 13, further comprising measuring the operating parameters including settings of the plurality of units of equipment.

16. The method of claim 13, wherein the first carbon dioxide emissions and the second carbon dioxide emissions are cumulative carbon emissions to reach the target operating state.

17. The method of claim 13, wherein the second transitionary state includes turning on at least one of the plurality of units of equipment.

18. The method of claim 13, further comprising, after changing the production facility to the first transitionary state or the second transitionary state:
measuring new operating parameters of the plurality of equipment units;
based on the new operating parameters, generating a new current operating state;
based on the new operating parameters and the facility input, generating a new first transitionary state between the new current operating state and the target operating state, the new first transitionary state having new first carbon dioxide emissions based on changing the new operating parameters;
based on the new operating parameters and the facility input, generating a new second transitionary state between the new current operating state and the target operating state, the new second transitionary state having new second carbon dioxide emissions based on changing the portion of the plurality of equipment units with the new operational parameters; and
based on the new first carbon dioxide emissions being lower than the new second carbon emissions, changing the oil and gas production facility to the new first transitionary state, and based on the new second carbon emissions being lower than the new first carbon emissions, changing the oil and gas production facility to the new second transitionary state.

19. A system, comprising:
a processor and memory, the memory including instructions executable at an oil and gas processing facility operating at a current operating state, wherein the instructions cause the processor to:
apply a first predictive controller to the current operating state to generate a first transitionary state between the current operating state and a target operating state, the first transitionary state utilizing a first combination of equipment operating in the current operating state and resulting in first carbon dioxide emissions;
apply a second predictive controller to the current operating state to generate a second transitionary state between the current operating state and the target operating state, the second transitionary state utilizing a second combination of equipment different than the first combination of equipment and resulting in second carbon dioxide emissions; and
select one of the first transitionary state or the second transitionary based on the first carbon dioxide emissions and the second carbon dioxide emissions.

20. The system of claim 19, wherein the instructions further cause the processor to implement the selected one of the first transitionary state or the second transitionary state.
